(19) United States
(12) Patent Application Publication
(10) Pub. No.: US 2015/0095582 A1
(43) Pub. Date: Apr. 2, 2015

(54) Method for Specifying Packet Address Range Cacheability

(71) Applicant: Avaya, Inc., Basking Ridge, NJ (US)

(72) Inventor: Hamid Assarpour, Arlington, MA (US)

(73) Assignee: Avaya, Inc., Basking Ridge, NJ (US)

(21) Appl. No.: 14/041,751

(22) Filed: Sep. 30, 2013

(51) Int. Cl. G06F 12/12

(52) U.S. Cl. CPC G06F 12/12
USPC 711/133

(57) ABSTRACT

A method for specifying packet address range cacheability is provided. The method includes passing a memory allocation request from an application running on a network element configured to implement packet forwarding operations to an operating system of a network element, the memory allocation request including a table ID associated with an application table to be stored using the memory allocation. The method also includes allocating a memory address range by the operating system to the application in response to the memory allocation request, and inserting an entry in a cacheability register, the entry including the table ID included in the memory allocation request and the memory address range allocated in response to the memory allocation request.

### BACKGROUND

This disclosure relates to packet forwarding network elements and, more particularly, to a method for specifying packet address range cacheability.

### SUMMARY

The following Summary, and the Abstract set forth at the end of this application, are provided herein to introduce some concepts discussed in the Detailed Description below. The Summary and Abstract sections are not comprehensive and are not intended to delineate the scope of protectable subject matter which is set forth by the claims presented below. All examples and features mentioned below can be combined in any technically possible way.

In one aspect, a method for specifying packet address range cacheability is provided. The method includes passing a memory allocation request from an application running on a network element configured to implement packet forwarding operations to an operating system of a network element, the memory allocation request including a table ID associated with an application table to be stored using the memory allocation. The method also includes allocating a memory address range by the operating system to the application in response to the memory allocation request, and inserting an entry in a cacheability register, the entry including the table ID included in the memory allocation request and the memory address range allocated in response to the memory allocation request.

In another aspect a memory allocation request operating system call includes an application ID, a table ID, and a memory allocation size.

In another aspect a network element includes a network processing unit, a cache associated with the network processing unit, a physical memory connected to the network processing unit and not implemented as part of the cache, a plurality of tables stored in the memory, at least part of the plurality of tables also being duplicated in the cache, and a cacheability register containing entries specifying cacheability of address ranges in the physical memory on a per table ID basis.

### BRIEF DESCRIPTION OF THE DRAWINGS

Aspects of the present invention are pointed out with particularity in the claims. The following drawings disclose one or more embodiments for purposes of illustration only and are not intended to limit the scope of the invention. In the following drawings, like references indicate similar elements. For purposes of clarity, not every element may be labeled in every figure.

FIGS. 1-2 are block diagrams of example memory systems for use in a network element.

FIG. 3 is a block diagram of an example memory allocation command according to an embodiment.

FIG. 4 is a block diagram of an example memory system for use in network elements according to an embodiment.

FIG. 5 is a block diagram of an example cacheability register according to an embodiment.

FIG. 6 is a flow diagram showing a lookup operation for a packet in an example memory system according to an embodiment.

FIG. 7 is a flow diagram showing a process implemented by an example memory system when a cache miss occurs according to an embodiment.

FIG. 8 is a flow diagram showing the exchange of information between physical components of the example memory system when implementing the process of FIG. 7.

FIG. 9 is a functional block diagram of an example network element according to an embodiment.

FIG. 10 is a block diagram showing physical components of the example network element of FIG. 9.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

Data communication networks may include various switches, nodes, routers, and other devices coupled to and configured to pass data to one another. These devices will be referred to herein as “network elements”. Data is communicated through the data communication network by passing protocol data units, such as frames, packets, cells, or segments, between the network elements by utilizing one or more communication links. A particular protocol data unit may be handled by multiple network elements and cross multiple communication links as it travels between its source and its destination over the network.

Network elements are designed to handle packets of data efficiently to minimize the amount of delay associated with transmission of the data on the network. Conventionally, this is implemented by using hardware in a forwarding plane of the network element to forward packets of data, while using software in a control plane of the network element to configure the network element to cooperate with other network elements on the network. For example, a network element may include a routing process, which runs in the control plane, that enables the network element to have a synchronized view of the network topology so that the network element is able to forward packets of data across the network toward their intended destinations. Multiple processes (applications) may be running in the control plane to enable the network element to interact with other network elements on the network, provide services on the network by adjusting how the packets of data are handled, and forward packets on the network.

The applications running in the control plane make decisions about how particular types of traffic should be handled by the network element to allow packets of data to be properly forwarded on the network. As these decisions are made, the control plane programs the hardware in the forwarding plane to enable the forwarding plane to be adjusted to properly handle traffic as it is received. For example, the applications may specify network addresses and ranges of network addresses as well as actions that are to be applied to packets addressed to the specified addresses.

The data plane includes Application Specific Integrated Circuits (ASICs), Field Programmable Gate Arrays (FPGAs), and other hardware elements designed to receive packets of data, perform lookup operations on specified fields of packet headers, and make forwarding decisions as to how the packet should be transmitted on the network. Lookup operations are typically implemented by a Network Processing Unit (NPU) using tables containing entries populated by the control plane. The tables are stored in external memory as well as in an on-chip cache. These tables are used by the forwarding plane to implementing forwarding decisions, such as to implement packet address lookup operations.

A packet processor generally has very fast on-chip memory (cache) and has access to off chip memory. The cache is typically fairly small, when compared to off-chip memory, but provides extremely fast access to data. Typically the off-chip memory is implemented using less expensive slower memory, such as Double Data Rate Synchronous Dynamic Random-Access Memory (DDR-SDRAM), although other memory types may be used as well. Lookup operations are typically implemented both in the cache and the external memory in parallel. As used herein, the term “cache miss” will be used to refer to a lookup operation that does not succeed in locating a result in the cache.

Since the cache is small, it is important to closely regulate what data is stored in the cache. Specifically, since the cache memory is much faster than off-chip memory, the NPU will try to keep the most relevant information in the cache by updating the cache. This enables the number of cache misses to be minimized which, accordingly, improves overall performance of the network element. Accordingly, when a cache miss occurs, the NPU will look to determine whether the value that caused the cache miss should be added to the cache. Generally, when a value (e.g. address) is added to the cache, that means that another address is removed from the cache. Many algorithms have been developed to optimize placement of data in the cache once a decision has been made to update the cache.

Before a decision is made as to whether a particular value should be stored in the cache, a cacheability determination is made based on the location where the value will be stored in physical memory. The Operating System breaks the physical memory space into equal size pages and is able to specify, on a per-page basis, whether a particular physical page of memory is cacheable or not. For packet processing, it is desirable to store critical tables that are used for every packet in the cache, and to store non-critical tables (that are used only with packets having particular features) in the off-chip memory. Unfortunately, physical memory allocation is done on a per application basis, which means that cacheability likewise is currently specified on a per application basis rather than a per-table basis.

Each application has a virtual address space in which it stores data. A Memory Allocation (MALLOC) Operating System (OS) call, or other OS call, is used to allocate physical memory to the application and a mapping is created between the virtual address space and the physical memory. Conventionally, the OS memory allocation command specifies the identification of the application requesting the memory allocation (process ID) and the size of physical memory to be allocated, but does not provide an indication of the content to be stored in the physical memory.

As noted above, the OS specifies physical memory ranges as cacheable or not cacheable on a per-page basis. This cacheability determination is made by the OS based on the process ID. If a cache miss occurs which is from a physical page of memory that is determined not to be cacheable, the miss will not be passed to the cache controller so that no update to the cache occurs. If a miss occurs from a physical page of memory that is determined to be cacheable, then the miss will be passed to the cache controller which implements any known cache updating scheme to determine whether the cache miss should cause a cache update to occur.

Current cacheability schemes thus operate at the process level. However, not all tables from a given process may be sufficiently important to warrant placement in the cache. In packet processing, this means that implementing a cacheability determination at the physical level is less than ideal. Specifically, where a given application is responsible for maintaining both critical tables and non-critical tables, the memory allocations associated with the application are either all indicated as cacheable or all indicated as not cacheable since the operating system specifies all memory allocated to the application as either cacheable or not cacheable. Further, in a system where cacheability is specified on a per physical memory page basis, it is possible for a given page of memory to contain both addresses that should be maintained in the cache and other portions that should not be maintained in the cache. This leads to sub-optimal cache performance either due to over-inclusion or under-inclusion of information in the cache which can slow overall network element performance.

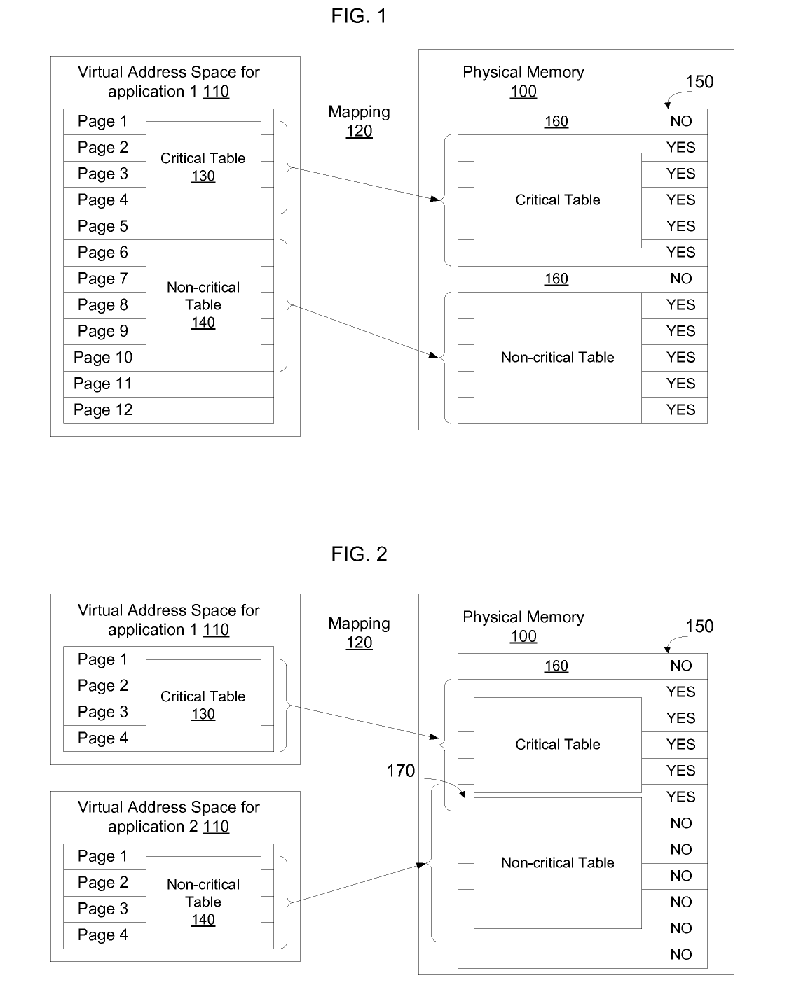

FIG. 1 shows an example of how this occurs. As shown in FIG. 1, an application uses a MALLOC or other memory allocation command to obtain an allocation of physical memory 100 which the network element will use to store data for the application. To insulate the application from the underlying hardware, the application uses a virtual address space 110 to store information, which is then mapped 120, e.g. by the operating system, to the physical memory locations that have been allocated to the application.

The application may store information associated with critical tables 130 and non-critical tables 140. However, as noted above, when the MALLOC is performed, the memory allocation command that causes the operating system to allocate physical memory to the application only includes the application ID/process ID and an indication as to whether information associated with that application ID or process ID is cacheable. Accordingly, as shown in FIG. 1, each of the pages 160 of physical memory allocated by the operating system to store data for the application will be deemed to be cacheable (150=YES). This includes pages 160 required to store critical tables 130 as well as pages 160 required to store non-critical tables 140.

FIG. 2 shows another example in which two applications have tables mapped to the same page 160 of physical memory. In the example shown in FIG. 2, two applications have been allocated physical memory. Application 1 has a critical table 130 that should be deemed to be cacheable whereas application 2 has a non-critical table that should be deemed to be non-cacheable. However, due to the physical memory allocation, a portion of both of the critical and non-critical tables are stored in the same page 170 of physical memory 100. Since physical memory pages may be specified as cacheable or non-cacheable, this will result in either a portion of the critical table being deemed non-cacheable, or a portion of the non-critical table being deemed to be cacheable.

Specifically, if the page 170 is deemed to be cacheable, as shown in FIG. 2 (cacheable 150=YES), values from the non-critical table that are determined to be stored in physical memory page 170 will be determined to be cacheable, which potentially will cause those values to be stored in the cache to the exclusion of other more important information. Conversely, if the page 170 is deemed to be non-cacheable, values from the critical table that are determined to be stored in physical memory page 170 will be determined to be non-cacheable and hence not included in the cache. In either instance, this will result in sub-optimal use of the cache.

Accordingly, it would be advantageous to provide a method for specifying packet address range cacheability to enable cacheability to be more finely controlled by the packet forwarding hardware of a network element.

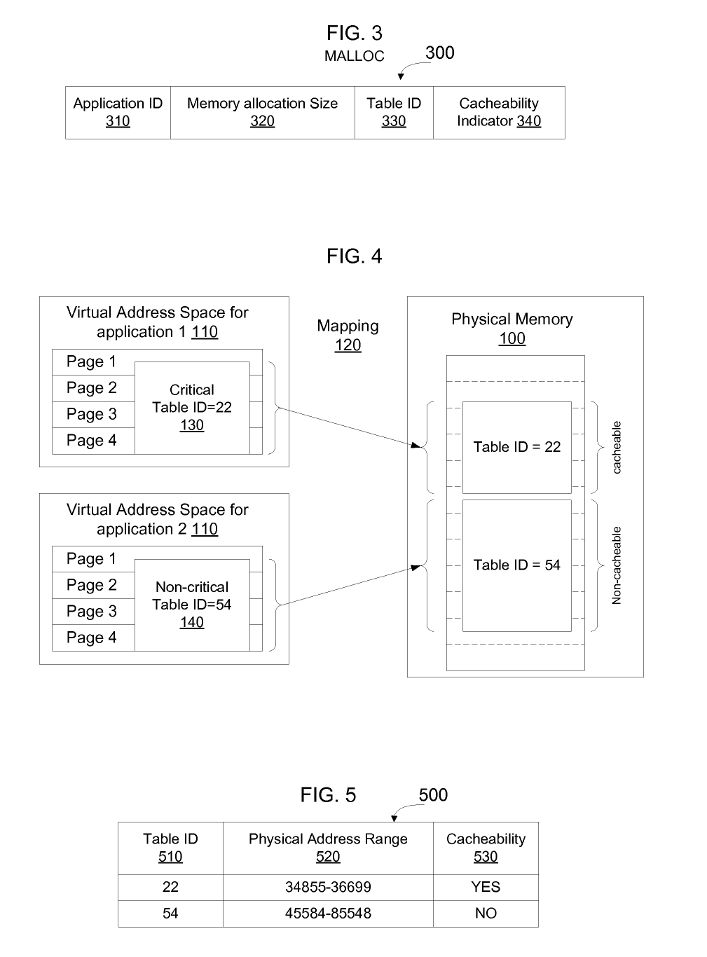

FIG. 3 shows an example memory allocation command. According to an embodiment, as shown in FIG. 3, when an application passes a Memory Allocation Request 300 such as a MALLOC to the operating system, the memory allocation request includes the application ID 310, memory allocation size 320, and application table ID 330. This enables applications to request physical memory for storage of particular tables or other logical groups of information.

The OS allocates memory and passes the physical memory allocation back to the application. The application or another application such as a management application specifies cacheability, e.g. by setting a cacheability indicator, to the OS according to application table ID, rather than on a per-application basis. The cacheability indicator may be included in the MALLOC or may be specified separately, for example by causing the application or management application to specify which application table IDs are to be considered to be cacheable.

The OS maintains a set of address range registers (also referred to herein as cacheability registers) that are used to keep track of which address ranges are deemed to be cacheable and/or which address ranges are deemed to be not cacheable. The cacheability instructions (on a per table ID basis) are used to set the information into this set of address range registers. Hence, the OS uses the cacheability indication for the application table ID to set cacheability indications for the physical memory that was allocated in response to the memory allocation associated with the application table ID. Since physical memory is not required to be allocated on a per-page basis, this enables particular ranges of physical addresses to be specified as cacheable or non-cacheable without regard to physical memory page boundaries.

By specifying cacheability at the application table ID level, the application can request physical memory to be allocated to its tables and, either in the memory allocation request or at a later time, specify to the operating system that physical memory allocated in connection with a particular table ID should be deemed to be cacheable or not cacheable. This allows the applications to control which tables occupy the cache to increase optimization of cache usage and hence lower latency of packet processing by increasing the overall cache hit rate of the network element.

FIG. 4 shows an example in which cacheability is specified for application table IDs. As shown in FIG. 4, the physical memory 100 is divided into pages in much the same way as physical memory 100 was divided into pages 160 in FIGS. 1-2. However, when physical memory is allocated in response to a memory allocation request such as the MALLOC shown in FIG. 3, the table ID is entered into a cacheability register 500, an example of which is shown in FIG. 5. Specifically, as shown in FIG. 5, the operating system inserts the table ID 510 and allocated address range 520 that will be used in physical memory to store the table. Either in the MALLOC or at a subsequent period of time the operating system is informed as to whether the table associated with the table ID should be considered cacheable or not cacheable. The operating system uses the cacheability information 530 to update the cacheability register 500 so that the physical memory ranges associated with particular memory allocations are specified as cacheable or not cacheable on a per-table ID basis. As shown in FIG. 4, this has the effect of causing particular address ranges to be deemed to be cacheable or non-cacheable without regard to the physical memory page boundaries.

The cacheability of the tables can be adjusted as well to adjust performance of the network element, in operation, by dynamically adjusting which tables are considered cacheable and which are not considered cacheable. Specifically, the same mechanism that is used to initially instruct the operating system as to which table IDs are cacheable or non-cacheable may be used to update the cacheability determination, to cause the operating system to update the cacheability indication 530 for the table in the cacheability register 500. For example, where a management application is used to set the cacheability information to the Operating System, the management application may likewise be used to change the cacheability information on a dynamic basis to adjust which tables are considered cacheable/not cacheable to adjust performance of the network element.

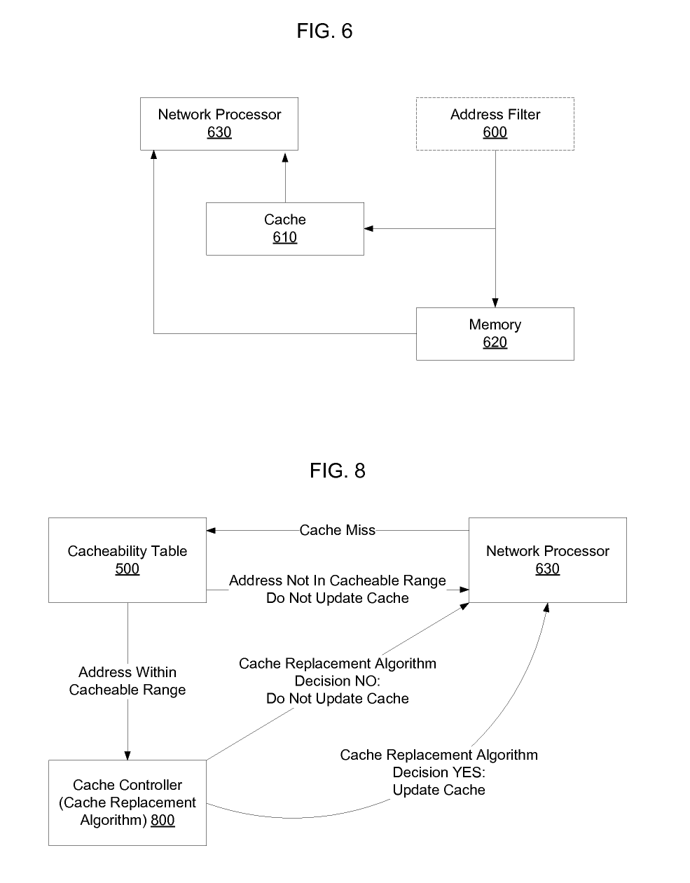

FIG. 6 illustrates the flow of a packet address in connection with implementation of a packet lookup operation. As shown in FIG. 6, the packet address will first be passed through an optional packet address filter 600 which causes addresses within particular ranges to be dropped. The filter enables the number of address lookup operations to be reduced by causing packets to be dropped before the lookup occurs. Other embodiments may not use a pre-filter.

The packet address is then passed, in parallel, to the cache 610 and physical memory 620. The cache may contain an entry for the packet address or it may not, depending on the content of the cache at the time. If the cache contains an entry it will provide it to the network processor 630. Optionally, in this event, the network processor 630 may instruct the memory 620 to stop work on resolving the packet address. The memory 620 (physical memory) contains all table entries including those in the cache, so if an entry exists for the packet address the memory 620 will return a result to the network processor 630.

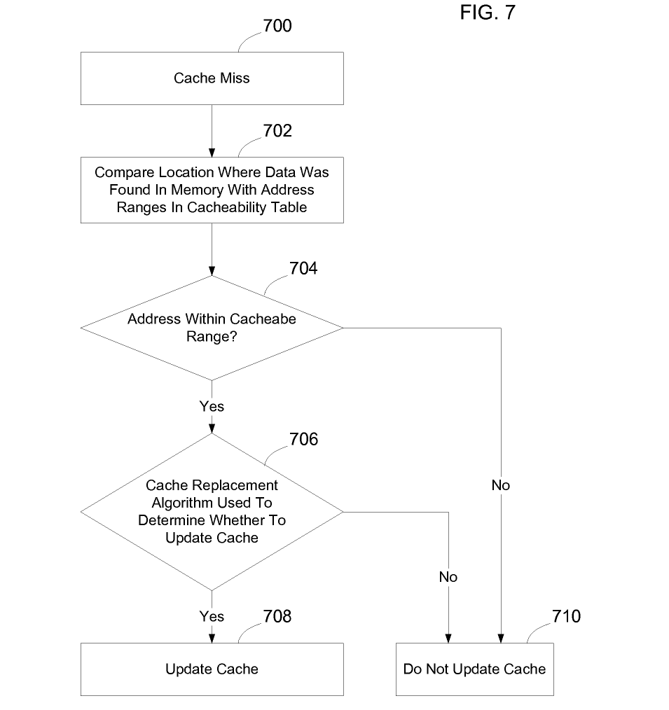

When a packet address is not contained in the cache, and is contained in memory 620, a cache miss occurs. FIG. 7 shows a process, according to an embodiment, that may be implemented when a cache miss is detected. FIG. 8 shows the corresponding flow of information between the network processor 630, cacheability table 500, and cache controller 800. Cache controller 800 may be implemented by a process running on network processor 630 but, for ease of explanation, has been illustrated as a separate component.

Specifically, as shown in FIG. 7, when a lookup occurs and a cache miss is detected (700), the physical address from memory 620 where the entry was located is compared with the address ranges in the cacheability address range registers (702, 704). If the address is indicated within the cacheability address range registers as being cacheable (Yes at block 704), then the address will be passed to the cache controller for selective placement in the cache (706). If the address is indicated by the address range registers as not cacheable (No at block 704), the address is not passed to the cache.

As noted in block 706, the cache controller implements any cache replacement algorithm to determine whether the cache miss should cause a cache update. This enables, for example, multiple cacheable tables to have different priorities relative to storage in the cache. The particular cache replacement algorithm implemented by the cache controller in connection with selective placement in the cache is outside the scope of the current disclosure as any cache replacement algorithm may be implemented in connection with addresses that pass the cacheability determination discussed herein. If the cache controller determines, using the cache replacement algorithm, that the cache should be updated (Yes at block 706), then the cache will be updated (708). If not (No at block 706) the cache will not be updated (710).

By specifying cacheability based on application table ID rather than or in addition to application ID, enhanced control over the cache may be obtained to thus ensure that only addresses associated with particular critical application tables are deemed to be cacheable. This, in turn, increases the hit rate in the cache and hence the overall latency of packet processing is reduced. Performance of the network element may be changed by changing the cacheability on a per application table basis as well.

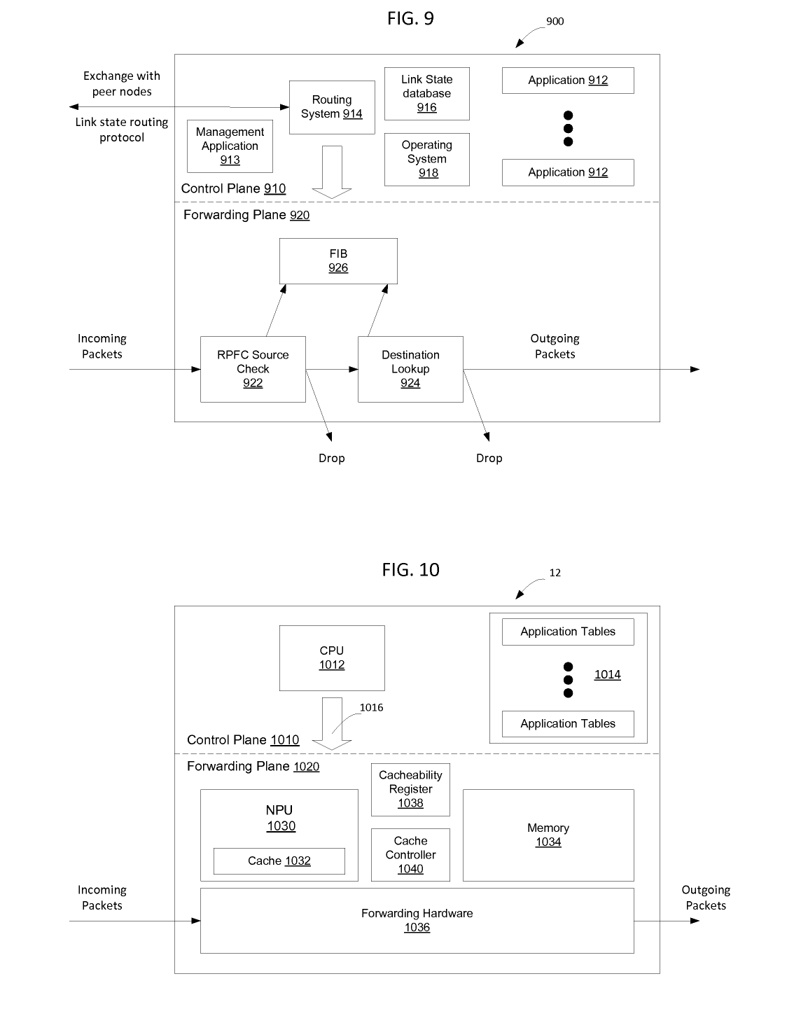

FIG. 9 illustrates an example network element configured to specify packet address range cacheability. As shown in FIG. 1, network element 900 includes a control plane 910 and a forwarding plane 920. Applications 912 run in the control plane and control operation of the network element on the network. One example application illustrated in FIG. 9 is routing system application 914. Routing system application 914 exchanges control packets with peer nodes to obtain information about the topography of the network to enable the network element to correctly forward packets through the network. For example, where the routing system is a link state protocol routing application, the routing system 914 exchanges link state routing protocol control packets such as link state advertisements and uses the information from the link state advertisements to build a link state database 916. Link state database 916 is one example of a table that may be programmed by the control plane into memory 1034 of the forwarding plane 920.

Applications 912, including routing system application 914, obtain physical memory allocations for tables supported by the applications from operating system 918. According to an embodiment, the applications 912, 914, or a management application 913 further specifies to the operating system whether the tables are cacheable or not cacheable. Operating system 918 causes this cacheability determination to be implemented in cacheability registers as discussed herein.

In the forwarding plane 920, incoming packets are received and one or more preliminary processes are implemented on the packets to filter packets that should not be forwarded on the network. For example, in FIG. 9 the forwarding plane is configured to perform a reverse path forwarding check 922 to drop packets that have been received on an incorrect interface. Optionally this may require a packet address lookup operation in a forwarding information base 926. Those packets that pass the initial filter(s) are passed to the network element which implements a packet address lookup operation in forwarding information base 926 to enable a forwarding decision to be implemented for the packet.

FIG. 10 is a functional block diagram of a network element showing the physical components rather than the logical processes which are discussed above in connection with FIG. 9. In the example shown in FIG. 10, the network element 1000 includes control plane 1010 and forwarding plane 1020. Other architectures may be implemented as well.

The control plane includes a CPU 1012 and memory 1014. Applications running in the control plane store application tables in memory 1014. Some of the application tables are programmed into the forwarding plane 1020 as indicated by arrow 1016.

Forwarding plane 1020 includes network processing unit 1030 having cache 1032. Forwarding plane further includes memory 1034 and forwarding hardware 1036. Memory 1034 and cache 1032 store packet addresses to enable packet lookup operations to be performed by the forwarding plane 1020. According to an embodiment, cacheability register 1038 is provided to store cacheability information on a per table ID basis. The cacheability registers are used by the cache controller 1040 to determine whether a cache miss should generate a cache update. This initial determination is based on the physical memory location where an address was stored in memory 1034 when the corresponding address was not located in the cache. If the cacheability registers indicate that the physical address is associated with a range of addresses that has been specified as cacheable, the cache controller 1040 further implements a cache update algorithm to determine whether to update the cache or not. Accordingly simply having an indication in the cacheability registers that indicates that a value is cacheable does not necessarily mean that the cache will be updated to include information associated with the physical address. Rather, once the address range is determined to be cacheable, the cache controller will implement a second process to determine whether to update the cache.

The functions described herein may be embodied as a software program implemented in control logic on a processor on the network element or may be configured as a FPGA or other processing unit on the network element. The control logic in this embodiment may be implemented as a set of program instructions that are stored in a computer readable memory within the network element and executed on a microprocessor on the network element. However, in this embodiment as with the previous embodiments, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible non-transitory computer-readable medium such as a random access memory, cache memory, read-only memory chip, a computer memory, a disk, or other storage medium. All such embodiments are intended to fall within the scope of the present invention.

It should be understood that various changes and modifications of the embodiments shown in the drawings and described herein may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method for specifying packet address range cacheability, the method comprising the steps of:
passing a memory allocation request from an application, running on a network element configured to implement packet forwarding operations, to an operating system of the network element, the memory allocation request including a table ID associated with an application table to be stored using the memory allocation;
allocating a memory address range by the operating system to the application in response to the memory allocation request; and
inserting an entry in a cacheability register, the entry including the table ID included in the memory allocation request and the memory address range allocated in response to the memory allocation request.

2. The method of claim 1, wherein the memory allocation request further includes a memory allocation size and an application ID.

3. The method of claim 1, further comprising setting a cacheability indicator for the entry in the cacheability register, the cacheability indicator specifying whether a cache miss associated with a memory address within the allocated memory address range will trigger a cache update operation.

4. The method of claim 3, wherein the step of setting the cacheability indicator is derived from information contained in the memory allocation request.

5. The method of claim 3, further comprising receiving first cacheability information associated with the table ID from a management application, and wherein the step of setting the cacheability indicator is derived from the first cacheability information.

6. The method of claim 5, further comprising the steps of:
receiving second cacheability information associated with the table ID from the management application; and
changing the cacheability indicator for the entry in the cacheability register, based on the second information.

7. The method of claim 6, wherein the first information comprises an indication that the memory allocation associated with the table ID is cacheable such that a cache miss associated with a memory address within the allocated memory address range will trigger a cache update operation.

8. The method of claim 7, wherein the second information comprises an indication that the memory allocation associated with the table ID is not cacheable such that a cache miss associated with a memory address within the allocated memory address range will not trigger a cache update operation.

9. The method of claim 3, wherein the cache update operation comprises execution of a cache replacement algorithm to selectively update the cache.

10. A memory allocation request operating system call, comprising:
an application ID;
a table ID; and
a memory allocation size.

11. The memory allocation request operating system call of claim 10, wherein the memory allocation request operating system call further comprises a cacheability indication associated with the table ID.

12. A network element, comprising:
a network processing unit;
packet forwarding hardware under the control of the network processing unit;
a cache associated with the network processing unit;
a physical memory connected to the network processing unit and not implemented as part of the cache;
a plurality of packet address tables stored in the memory, at least part of the plurality of packet address tables also being duplicated in the cache; and
a cacheability register containing entries specifying cacheability of address ranges in the physical memory on a per packet address table ID basis.

13. The network element of claim 12, wherein the cacheability register entries are associated with memory allocations of physical memory, the cacheability register entries being created in response to memory allocation requests.

14. The network element of claim 12, further comprising a cache controller configured to use the entries in the cacheability register to implement a cacheability screening operation.

15. The network element of claim 14, wherein the cache controller is further configured to implement a cache replacement algorithm when a cache miss passes the cacheability screening operation.

16. The network element of claim 14, wherein the cacheability screening operation comprises comparing an address in physical memory with the entries in the cacheability register and determining, from one of the entries encompassing the address, whether the address is within a cacheable range of memory addresses.
